(19) United States
(12) Patent Application Publication
(10) Pub. No.: US 2011/0234750 A1
(43) Pub. Date: Sep. 29, 2011

(54) Capturing Two or More Images to Form a Panoramic Image

(76) Inventors: Jimmy Kwok Lap Lai, Vancouver (CA); Brett Anthony Cheng, Vancouver (CA)

(21) Appl. No.: 12/730,628

(22) Filed: Mar. 24, 2010

(51) Int. Cl. H04N 7/00

(52) U.S. Cl. 348/37; 348/E07.001

(57) ABSTRACT

A camera includes a display device, an angular velocity sensor to sense yaw rotation, an acceleration sensor to sense lateral and fore/aft acceleration, a memory to store first and second locations, and a processor. The angular velocity sensor is at the first location and the acceleration sensor is at the second location, and both locations are away from a center of perspective. The processor determines an initial position when an initial image is captured, a target position for capturing a next image, and a current position. The current position is determined from rotation sensed by the angular velocity sensor, acceleration sensed by the acceleration sensor, and the first and second locations. The processor causes a visual indication of the target position and a visual indication of the current position to be rendered on the display device. When the target and current positions are in substantial alignment, the camera automatically captures the next image.

### FIELD

This specification relates to properly capturing two or more images that may be combined to form a panoramic image.

### BACKGROUND

When a camera captures a photograph, it captures the scene in the field of view in front of the lens. A panoramic image may be created by using a wide angle lens. However, the use of a wide angle lens can distort the captured image. In addition, the maximum angle available for a wide angle lens is appreciably less than 360°. Alternatively, a panoramic image may be created by capturing images of two or more adjacent views and then combining the images, such as by “stitching” the images together.

A panoramic image may be viewed in the traditional manner as a two-dimensional planar representation. In addition, a panoramic image may also be viewed using special-purpose viewing software (“panorama viewer”). A panorama viewer typically has a display window in which a portion of the panoramic image is rendered, e.g., the display window shows a 40° field of view. The panorama viewer typically includes viewing controls that may be used, for example, to pan horizontally or vertically, or to zoom in or out. When a panorama viewer is used, it is often desirable to form panoramic images that are 360° horizontal images. In addition, it is sometimes desirable to form panoramic images that extend both 360° horizontally and 360° vertically, i.e., a spherical panorama. With such images, the panorama viewer may be used to represent a location in a virtual reality (“VR”) environment.

Accordingly, there is a need for capturing two or more images that may be combined to form a panoramic image. However, when the two or more images are captured, the images are often not properly captured, which in turn can lead to problems such as image artifacts and difficulty in stitching the images together. Accordingly, there is a need for a system, apparatus and method for properly capturing two or more images that may be combined to form a panoramic image.

### SUMMARY

This summary is not intended to fully describe the invention. It is provided only for generally determining what follows in the drawings, Detailed Description, and Claims. For this reason, this summary should not be used limit the scope of the invention.

One embodiment is directed to a camera that includes a display device, an angular velocity sensor, an acceleration sensor, a memory, and a processor. The angular velocity sensor senses yaw rotation of the camera when the camera is moved. In addition, the angular velocity sensor is at a first location with respect to and away from a center of perspective. The acceleration sensor senses lateral and fore/aft acceleration of the camera when the camera is moved. In addition, the acceleration sensor is at a second location with respect to and away from the center of perspective. The memory may be used to store the first and second locations. The processor determines an initial position, a target position, and a current position. The initial position is determined when an initial image is captured. The initial position corresponds with the center of perspective. The target position is a position for capturing a next image. The target position corresponds with the initial position. The current position is determined from rotation sensed by the angular velocity sensor, acceleration sensed by the acceleration sensor, and the stored first and second locations. The processor causes a visual indication of the target position and a visual indication of the current position to be rendered on the display device.

In one embodiment, the processor further determines when the target and current positions are in substantial alignment, and the camera automatically captures the next image when the target and current positions are in substantial alignment.

One embodiment is direct to a method for capturing two or more images. The method includes capturing an initial image of a scene using a camera, determining a target position for the camera, sensing at least one current position of the camera using an acceleration sensor, and displaying on a display device an indication of the target and current positions of the camera. The target position is determined so that the target position coincides with a center of perspective determined at substantially the same time as the capturing of the initial image. The at least one current position of the camera is sensed subsequent to the capturing of the initial image. In addition, the current position coincides with a current center of perspective.

In one embodiment, the method includes judging when the target and current positions substantially coincide, and capturing a next image when the target and current positions substantially coincide.

One embodiment is directed to a camera that includes a first sensor and a processor. The first sensor senses fore/aft displacement along a Z axis of the camera when the camera is moved. The processor determines an initial position when the initial image is captured, a target position for capturing a next image, and a current position from sensed fore/aft displacement. The initial position corresponds with a center of perspective. The target position corresponds with the initial position. In addition, the processor determines when the target and current positions are substantially equal, and allows capture of a next image when the target and current positions are determined to be substantially equal. The Z axis corresponds with an optical axis of the camera when the initial image is captured.

In one embodiment, the camera automatically captures a next image when the target and current positions are determined to be substantially equal.

In one embodiment, the camera includes a display device, and the processor causes a visual indication of the target position and a visual indication of the current position to be rendered on the display device.

### DETAILED DESCRIPTION OF THE DRAWINGS

Reference will now be made in detail to specific embodiments, examples of which are illustrated in the accompanying drawings. Wherever possible, the same reference numbers are used in the drawings and the description to refer to the same or like parts.

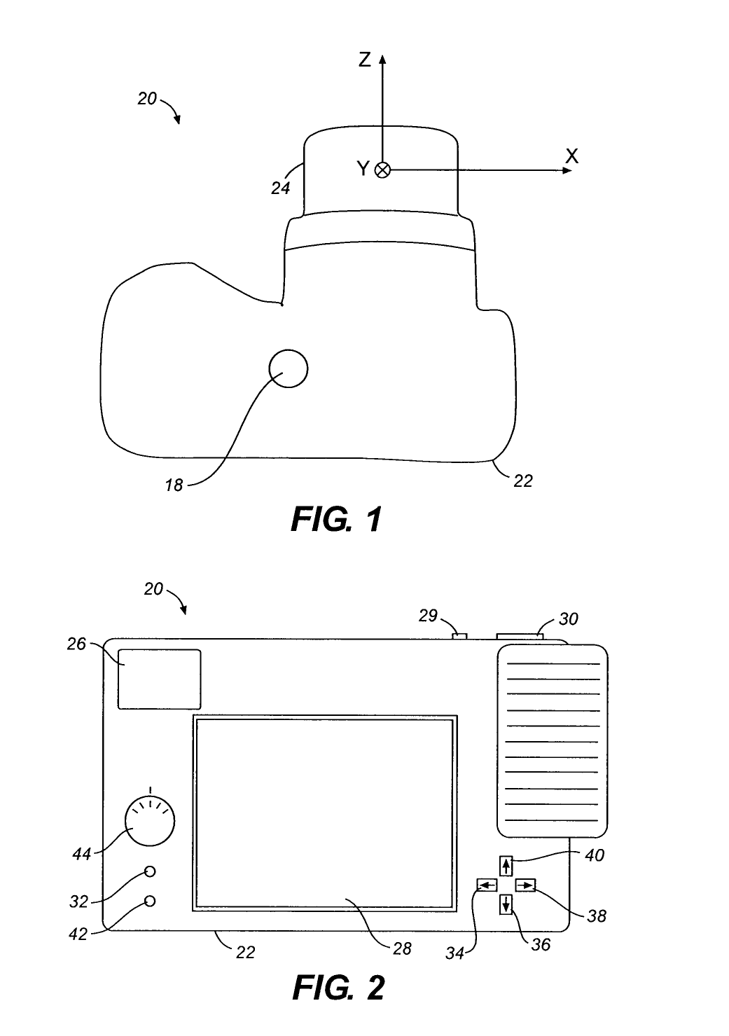

FIG. 1 illustrates a bottom side of one exemplary embodiment of a camera.

FIG. 2 illustrates a user side of the camera of FIG. 1, the camera including an image display.

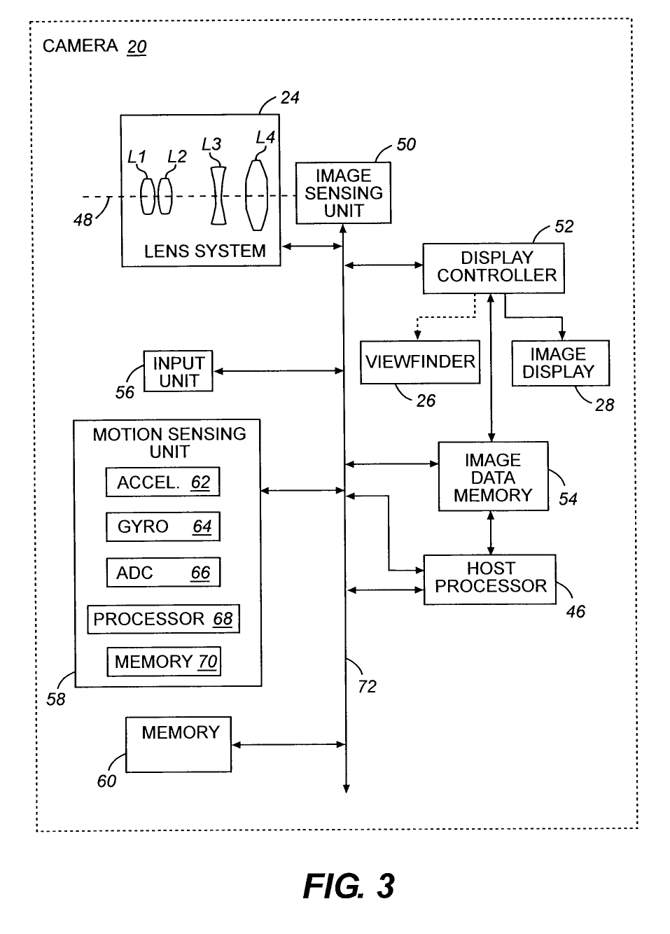

FIG. 3 is a block diagram showing selected components of the camera of FIGS. 1 and 2 according to one embodiment.

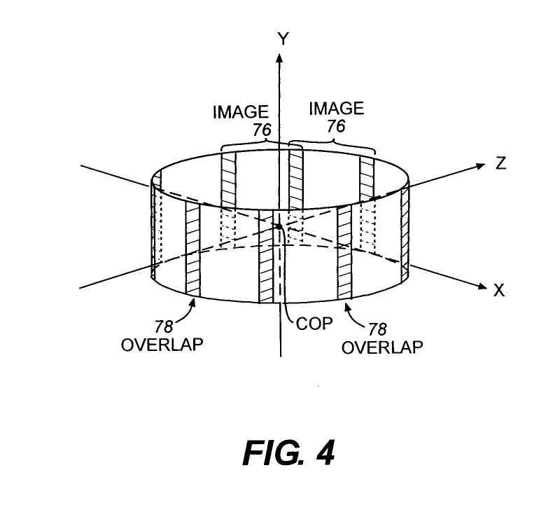

FIG. 4 shows exemplary horizontally overlapping images that may used to form a 360° cylindrical panoramic image.

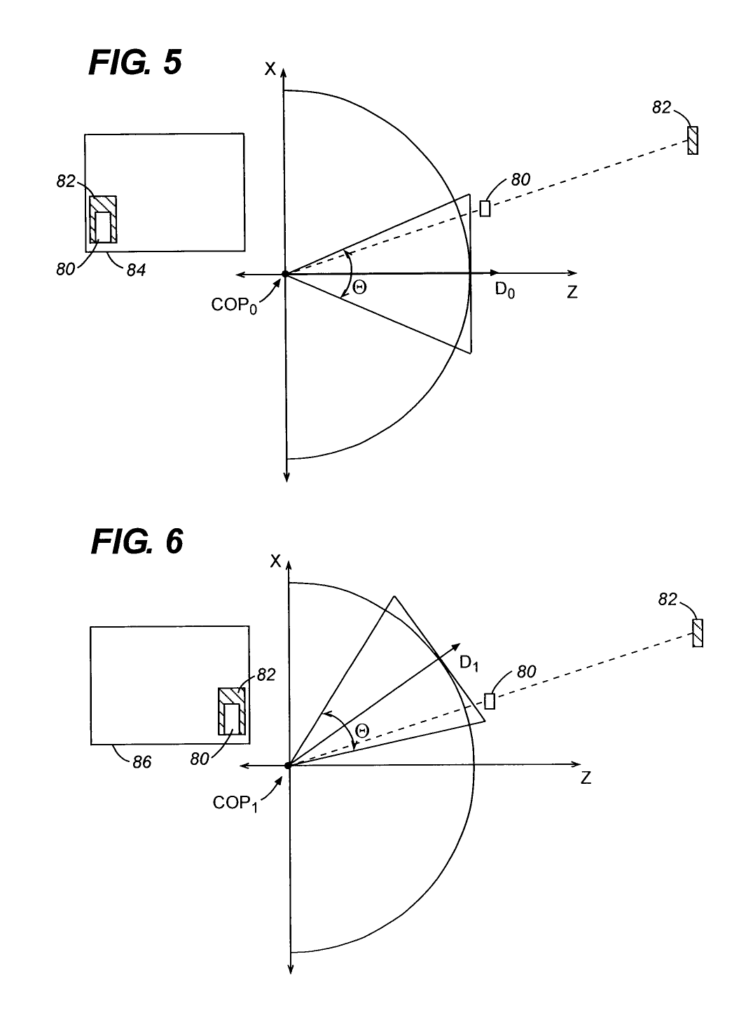

FIG. 5 shows a first field of view that may be captured by the camera of FIGS. 1 and 2 when the camera is being operated in panoramic mode.

FIG. 6 shows a first example of a second field of view that may be captured by the camera of FIGS. 1 and 2 when the camera is being operated in panoramic mode.

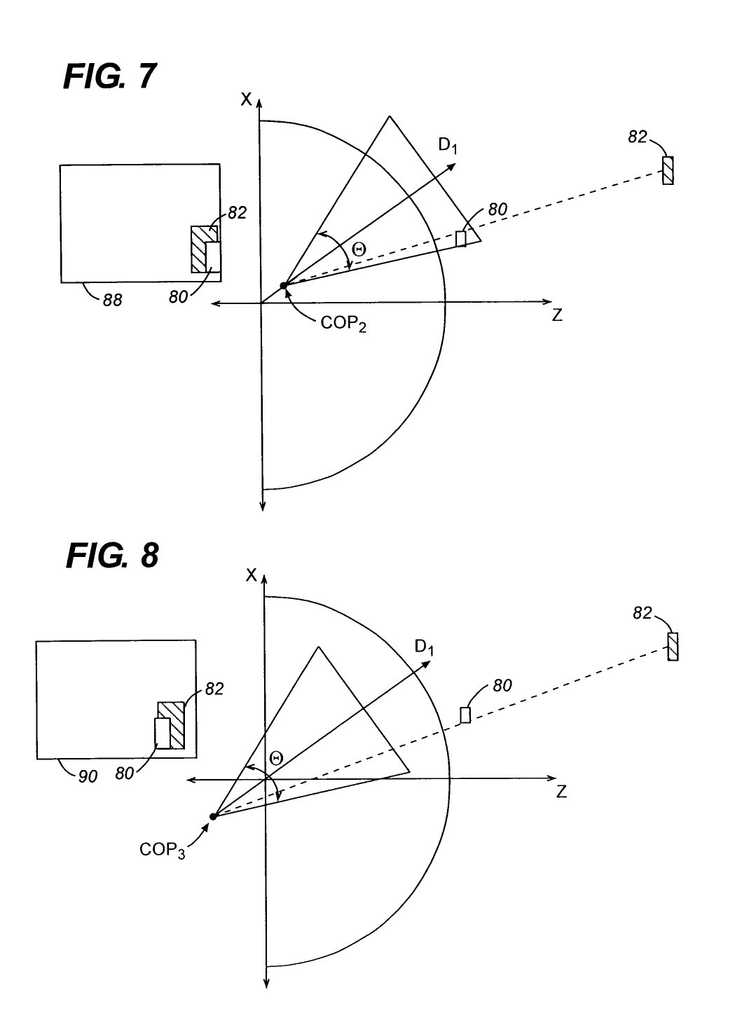

FIG. 7 shows a second example of the second field of view that may be captured by the camera of FIGS. 1 and 2 when the camera is being operated in panoramic mode.

FIG. 8 shows a third example of the second field of view that may be captured by the camera of FIGS. 1 and 2 when the camera is being operated in panoramic mode.

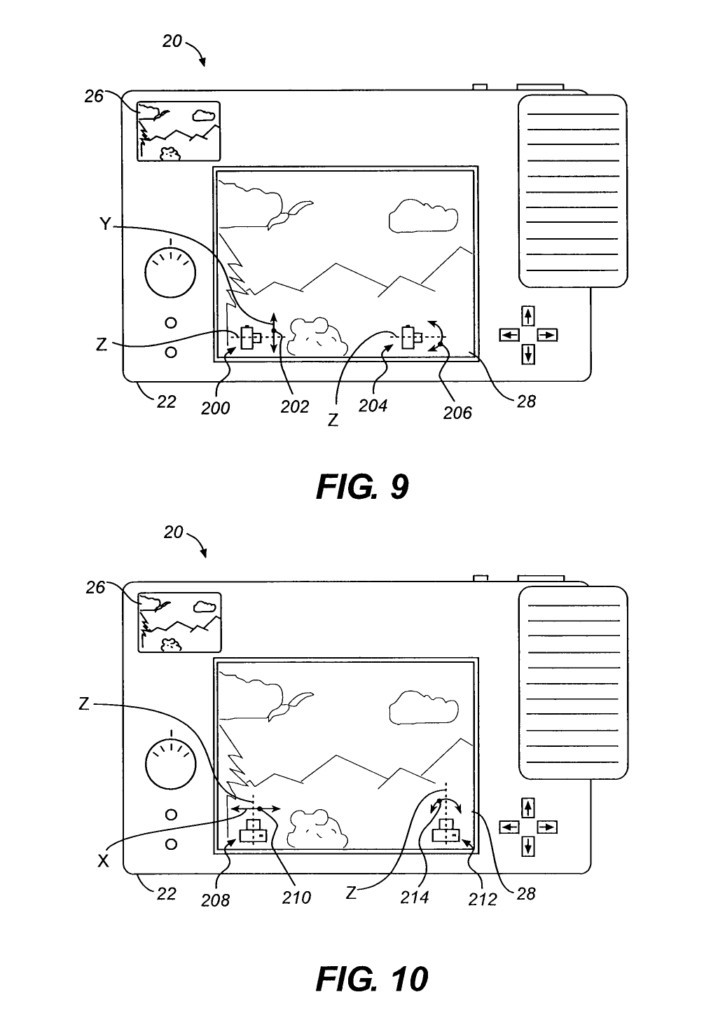

FIG. 9 illustrates a first example of current and target visual indications of position and orientation being rendered on the image display of the camera of FIGS. 1 and 2.

FIG. 10 illustrates a second example of current and target visual indications of position and orientation being rendered on the image display of the camera of FIGS. 1 and 2.

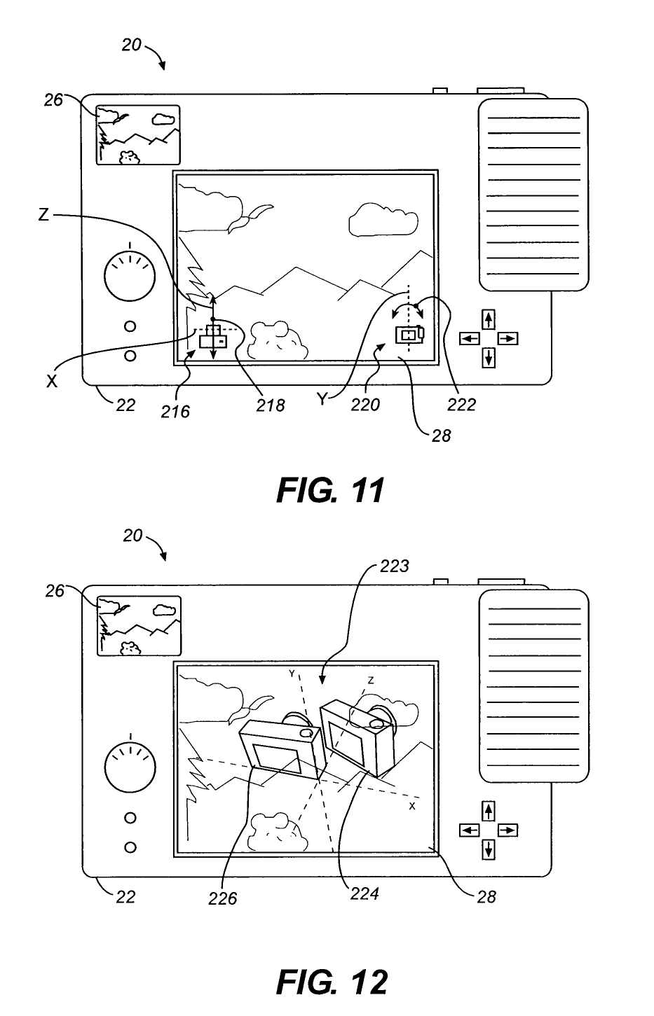

FIG. 11 illustrates a third example of current and target visual indications of position and orientation being rendered on the image display of the camera of FIGS. 1 and 2.

FIG. 12 illustrates a fourth example of current and target visual indications of position and orientation being rendered on the image display of the camera of FIGS. 1 and 2.

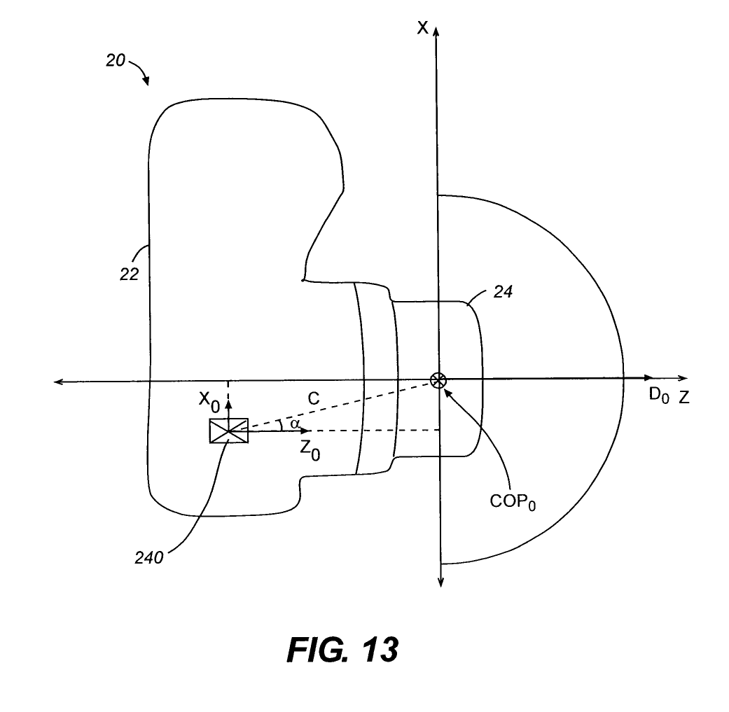

FIG. 13 illustrates example locations for a target center of perspective and a sensor for the camera of FIG. 1.

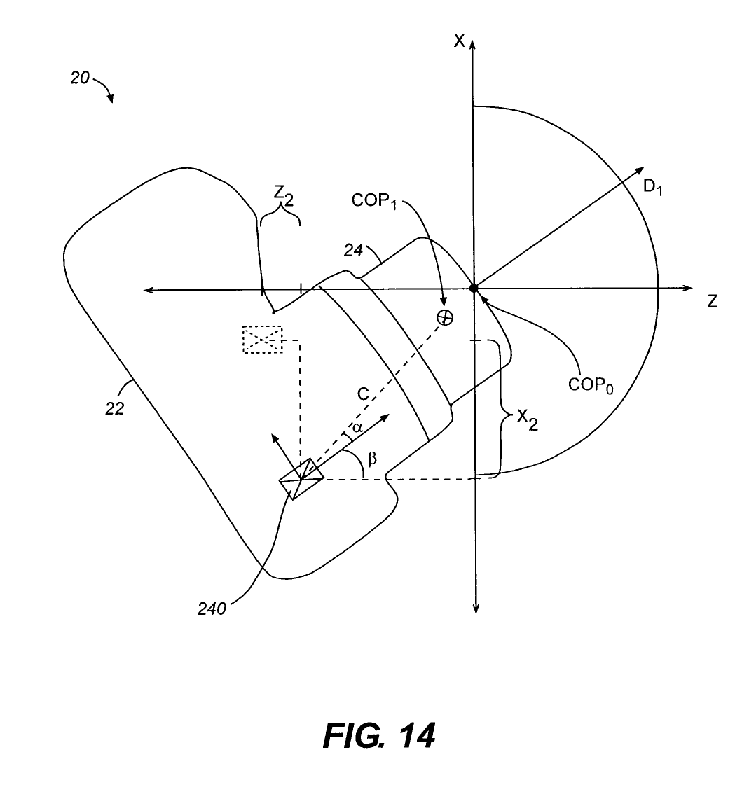

FIG. 14 illustrates example locations for a target and current center of perspectives and a sensor for the camera of FIG. 1.

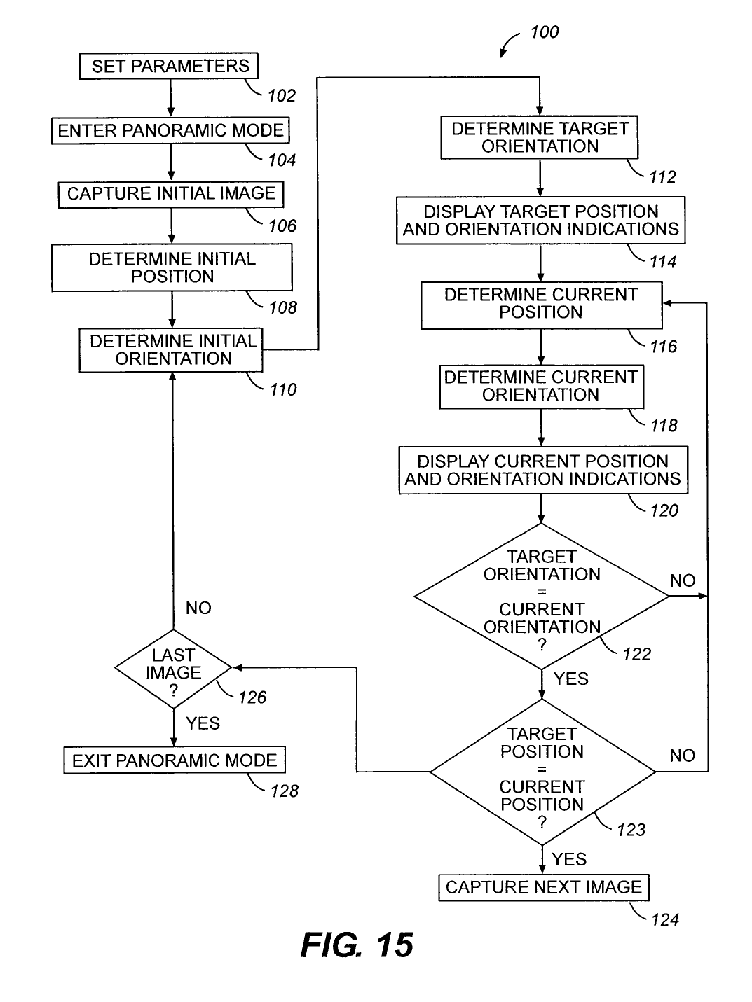

FIG. 15 shows a process 100 of capturing two or more images using the camera of FIGS. 1 and 2 according to one embodiment.

### DETAILED DESCRIPTION

Reference in this description to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

When two or more images are captured for the purpose of combining the captured images to form a panoramic image, the images are often not properly captured, which in turn can lead to problems such as image artifacts and difficulty in stitching the images together. One type of error that improperly captured images can occur have is parallax error. While parallax error is less noticeable when all captured objects are far from the camera, parallax error can be a significant problem when one or more objects are close to the camera.

FIGS. 1 and 2 illustrate a bottom and a user side, respectively, of one exemplary embodiment of a camera 20 that may be used to capture two or more images that may be combined to form a panoramic image while minimizing or eliminating parallax error. The camera 20 may be a single lens reflex (SLR) or a “point-and-shoot” type camera. The camera system 20 may capture images on film or using an image sensor. In alternative embodiments, the camera 20 may be a digital video recorder, or other device incorporating either a still image capture or video recording capability. For example, the camera 20 may be incorporated into a personal digital assistant, cellular telephone or other communications device.

In the shown embodiment, the camera 20 includes a tripod attachment 18, a body portion 22 and a lens portion 24. The lens portion 24 may provide for fixed or adjustable focus. The body portion 22 may include a viewfinder 26 and an image display 28. The shown camera 20 includes an on/off button 29 for powering the camera on and off, and a shutter button 30. The camera 20 may also include a menu button 32 for causing a menu to be displayed on the image display 28, arrow buttons 34, 36, 38, 40 for navigating a displayed menu, and a select button 42 for selecting a menu item. In addition, the camera 20 may include a mode dial 44 for selecting among various operational modes.

After capturing a first one of two or more images, the camera 20 may be positioned to capture a second image (and subsequent images) by rotating the camera body 22 about one or more axes: X-axis (pitch), Y-axis (yaw), or Z-axis (roll). As shown in the figure, the axes may intersect one another at a center of perspective. In addition, subsequent to the capture of the initial image, the location of the camera 20 in three-dimensional space, i.e., its “position,” may be changed by translating the camera body 22 along one or more of the axes: X-axis (lateral translation), Y-axis (vertical translation), or Z-axis (fore/aft translation). It will be appreciated that rotation or displacement in any manner or in any direction may be resolved into a combination of rotations and translations about or along the X-, Y- and Z-axes.

FIG. 3 is a block diagram showing selected components of the camera 20 of FIGS. 1 and 2 according to one embodiment. While the shown blocks are typically located within the camera body 22, in one embodiment, one or more of the blocks may be located externally.

Referring to FIG. 3, the camera 20 may include a host processor 46. The host processor 46 may issue commands to various components of the camera for the purpose of controlling camera functions. The host processor 46 may be a CPU, a digital signal processor (DSP), or another type of processor, or a state machine. The host processor 46 may be formed on an integrated circuit (IC). The host processor 46 may be operable to execute instructions. The instructions or software may enable the host processor 46 to perform known processing and communication operations. In addition, in one embodiment, the instructions or software enable the host processor 46 to perform the functions, further described below, for guiding the positioning of the camera 20 when it is used to capture two or more images that may be stitched together to form a panoramic image while minimizing or eliminating parallax error. Moreover, the host processor 46 may issue commands to control an image sensing unit 50, a display controller 52, a motion sensing unit 58, or other unit. Further, the host processor 46 may perform write or read operations to or from a memory or other unit.

The lens system 24 may include one or more lenses, e.g., L1-L4. The lens system 24 may also include a motor or other mechanism (not shown) for moving a lens for the purposes of changing focus or focal length. Additionally, the lens system 24 may include a sensor or other device (not shown) for detecting positions of the lenses. The host processor 46 may be coupled with the lens system 24 in order to control the lens movement mechanism and to receive information regarding lens positions. An optical axis 48 passes through the center of the lenses.

The camera 20 may include the image sensing unit 50. The host processor 46 may be coupled with the image sensing unit 50 in order to provide it with commands and to receive information and image data. The image sensing unit 50 may include a charge-coupled device (CCD) or complementary metal-oxide semiconductor (CMOS) type image sensor that converts light into electronic signals that represent the level of light at each pixel. Other image sensing devices that are known or may become known that are capable of converting an image formed by light impinging onto a surface into electronic signals representative of the image may also be used. The image sensing unit 50 also includes circuits for converting the electronic signals into image data and interfacing with other components of the system. For example, the image sensing unit 50 may include circuitry for de-mosaicing a Bayer pattern image into RGB pixels. In addition, the sensing unit 50 may include an electronic or mechanical shutter. The lens unit 24 and image sensing unit 50 may be referred to collectively as an “imaging apparatus.” In an alternative embodiment, the image sensing unit 50 may be replaced with any type of conventional photographic film and a mechanical shutter.

The camera 20 may include the display controller 52 and an image data memory 54. The image sensing unit 50 may transmit image data to the display controller 52, to the image data memory 54, or to the host processor 46. Typically, the image sensing unit 50 transmits image data to a destination specified by the host processor 46. The image data memory 54 may be used primarily, but not necessarily exclusively, for storing image data. The image data memory 54 may be used for temporarily storing image data. The image data memory 54 may include a frame buffer. The image data memory 54 may be an SRAM , DRAM, or may include both an SRAM and a DRAM.

The display controller 52 may receive commands from the host processor 46. The display controller 52 may issue commands to control the image sensing unit 50. The display controller 52 may read or write image data, non-image data, or software code to or from a memory, e.g., the image data memory 54 or memory 60. In one embodiment, the display controller 52 may furnish image data to the image display 28. In one embodiment, the display controller 52 may furnish image data to the viewfinder 26. The display controller 52 may also furnish control or timing signals, or both types of signals, to one or both of the viewfinder 26 and display 28. The display controller 52 may include image processing capabilities, such as capabilities for compressing image data, converting image data from one color space to another, scaling (up or down) image data, filtering image data, or other image processing functions.

The viewfinder 26 may be an optical viewfinder optically coupled with an aperture on the front side of the camera body 22 other than the lens system 24. In one embodiment, the viewfinder 26 may be an optical viewfinder optically coupled with the lens system 24, such as in an SLR arrangement. Further, the viewfinder 26 may be an optical viewfinder and computer-generated images may be overlaid or projected onto the viewfinder. In an alternative embodiment, the viewfinder 26 may be any type of display device currently available or which may become available that is capable of displaying an image. For example, the viewfinder 26 may be an LCD or an organic light emitting diode (OLED) display. While viewfinder 26 is typically placed on the back side of the body portion 22 as shown in FIG. 1, the viewfinder 26 may be placed at other locations on the body portion 22 or placed in a device remote from the camera. For example, the camera 20 may be operated with a remote control unit (RCU) having the viewfinder 26 mounted in the RCU. The viewfinder 26 allows a user to see the field of view or an estimate of the field of view that the lens “sees.” In embodiments, where computer-generated images are overlain or projected onto the viewfinder 26, the computer-generated images may include setting, status, or any other desired information. Where the viewfinder 26 is a display device, images captured by the imaging apparatus and setting, status, or other information may be rendered on the viewfinder 26.

The image display 28 may be may be any type of device currently available or which may become available that is capable of displaying an image. In one embodiment, the image display 28 may be an LCD. Alternatively, the image display 28 may be an OLED type display device. While image display 28 is typically placed on the back side of the body portion 22 as shown in FIG. 1, the image display 28 may be placed at other locations on the body portion 22 or placed in a device remote from the camera. For example, the camera 20 may be operated with an RCU having the image display 28 mounted in the RCU. In addition to menu related items, images captured by the imaging apparatus or stored in a memory, information and representations regarding camera position may be displayed on the image display 28.

The camera system 20 includes an input unit 56. The input unit 56 is coupled with various controls, such as the on/off button 29, shutter button 30, menu button 32, arrow buttons 34, 36, 38, 40, select button 42, and mode dial 44. In addition, input unit 56 is coupled with the host processor 46 in order that user commands may be communicated to the host processor 46. In one alternative, the input unit 56 may be coupled with the image sensing unit 50, display controller 52, or a motion sensing unit 58 in order to that user commands may be directly communicated to the particular unit.

The camera 20 may include a memory 60 that may be used as a system memory for storing software and data used by the host processor 46. The memory 60 may also be used for storing captured image data. The memory 60 may be a volatile or non-volatile (NV) memory. For example, the memory 60 may be an SRAM , DRAM, or may include both an SRAM and a DRAM. Additionally, the memory 60 may include a FLASH memory, an EEPROM, hard drive, or other NV media. The memory 60 may be non-removable, e.g., soldered. Alternatively, the memory 60 may be removable, e.g., “SD Card,” “Compact Flash,” or “Memory Stick.” The memory 60 may be a combination of removable and non-removable types. In one embodiment, the memory 60 is remote from the camera system 20. For example, the memory 60 may be connected to the system 20 via a communications port (not shown).

The camera 20 may include a BLUETOOTH interface or an IEEE 802.11 interface for connecting the system 20 with another system (not shown). In addition, the camera 20 may include a wireless communications link to a carrier.

The camera 20 includes a motion sensing unit (MSU) 58. The MSU 58 senses acceleration along at least one axis and relative rotation about at least one axis. In one embodiment, the MSU 58 includes an acceleration sensor 62, an angular rate sensor 64, an analog-to-digital converter (ADC) 66, an MSU processor 68, and an MSU memory 70. It is not critical that these units 62, 64, 66, 68, and 70 be physically located within a single unit or component; the units 62, 64, 66, 68, and 70 may be discrete units. Further, one or more of the units 62, 64, 66, 68, and 70 may be provided together within a single unit or component. The functions of the MSU processor 68 may optionally be performed by the host processor 46, in which case the MSU 58 need not include the MSU processor 68. Similarly, the functions of the MSU memory 70 may optionally be performed by the memory 60 or 54, in which case the MSU 58 need not include the MSU memory 70. The MSU 58 may be placed in an active mode in which the acceleration sensor 62 and the angular rate sensor 64 respectively sense acceleration and rotation. The MSU 58 may be placed in the active mode in response to a signal received from the host processor 46 or input unit 56.

The acceleration sensor 62 is used for sensing linear acceleration. The acceleration sensor 62 may output sensed acceleration data to the ADC 66, MSU processor 68, or host processor 46. In one embodiment, the acceleration sensor 62 senses linear acceleration along one or more axes. For example, referring to FIG. 1, the acceleration sensor 62 may sense linear acceleration along one or more of the x-, y- and z-axes. Alternatively, the acceleration sensor 62 may sense linear acceleration along one or more axes of the sensor. The acceleration sensor 62 may be one or more micro-electromechanical system (MEMS) devices. The acceleration sensor 46 may be of the capacitive, piezoelectric, piezoresistive, electromagnetic, ferroelectric, optical, or tunneling type.

The acceleration sensor 62 and the MSU processor 50 may be employed to determine displacement. When the acceleration sensor 62 detects acceleration along one or more axes of the sensor, it outputs one or more signals indicative of detected acceleration, i.e., an acceleration vector. From these signals, a velocity vector may be calculated by integrating the acceleration vector. Further, a displacement vector may be calculated by integrating the velocity vector. In one embodiment, the MSU processor 50 may perform these calculations. In this way, the acceleration sensor 62 in combination with the MSU processor 50 may be employed to determine displacement from an initial position of the acceleration sensor 62.

The angular rate or gyroscopic sensor 64 is used for sensing rotation. The angular rate sensor 64 may output sensed rotation data to the ADC 66, MSU processor 68, or host processor 46. In one embodiment, the angular rate sensor 64 senses rotation about one or more axes. For example, referring to FIG. 3, the angular rate sensor 64 may sense rotation about one or more of the x-, y- and z- axes. Alternatively, the angular rate sensor 64 may sense linear acceleration along one or more axes of the sensor. The angular rate sensor 64 may be one or more MEMS devices. The angular rate sensor 64 may be a Coriolis Vibratory Gyro (CVG) that includes a proof-mass of any desired shape. For example, the angular rate sensor 64 may be a CVG that includes a vibrating beam, tuning fork, shell, ring, wine-glass shape, or plate. The angular rate sensor 64 may include a crystalline quartz or silicon resonator. Out-of-plane oscillation may be detected in any manner. For example, out-of-plane oscillation may be detected by measuring capacitance or piezoelectric strain. In an illustrative embodiment, both the acceleration sensor 62 and the angular rate sensor 64 may be provided as part AH-6100LR, which includes a 3-axis QMEMS quartz gyro sensor and a 3-axis accelerometer in a single integrated circuit. The AH-6100LR part is available from Epson Electronics America, Inc., San Jose, Calif.

In one embodiment, the output of the angular rate sensor 64 may be used to determine error in the output of the acceleration sensor 62. Similarly, the output of the acceleration sensor 62 may be used to determine error in the output of the angular rate sensor 64. The MSU processor 68 may perform processing to process the output of one or both of the sensors 62, 64, using the output of the other sensor, in a manner such that the processed output has a reduced amount of error. In addition, the MSU processor 68 may perform other algorithms or processes for conditioning the output of the sensors 62, 64 for subsequent use. For example, the MSU processor 68 may perform low- or high-pass filtering. In one embodiment, the MSU 58 includes the ADC 66, which is employed to convert analog signals output by one or both of the sensors 62, 64 into digital signals. In one alternative, the sensors 62, 64 provide digital output and the ADC 66 may be omitted. In one embodiment, the ADC 66 may be integrated with another component, such as the MSU processor 68.

The MSU processor 68 may be a CPU, DSP, or another type of processor, or a state machine. The MSU processor 68 may be coupled with the display controller 52 and image data memory 54. The MSU processor 68 may be an IC and may be operable to execute instructions. In one illustrative embodiment, the MSU processor 68 is a microcontroller with a multi-channel, 12-bit ADC and a Flash/EE memory integrated on a single chip available from Analog Devices, Norwood, Mass. as either part number ADuC7128 (ARM7 microcontroller core) or ADuC841 (8052 microcontroller core). In another illustrative embodiment, the MSU processor 68 is the general purpose MCU with 8-channel ADC, part number S1C33109 available from Epson Electronics America, Inc., San Jose, Calif.

In one embodiment, the MSU 58 includes the MSU memory 70, which may include an SRAM type memory or a removable Flash memory, or both. The MSU memory 70 may store code to be executed by the MSU processor 68. The MSU memory 70 may store the results of trigonometric, square root, or floating point calculations that are pre-calculated based on possible locations of a center of perspective. The MSU memory 70 may store data related to calculations and functions that the MSU processor 68 performs. In one embodiment, the MSU memory 70 may be integrated with another component, such as the MSU processor 68.

FIG. 3 shows several lines connecting the components, units and devices described above. These lines represent paths of communication between the components, units and devices. The communication paths are shown as a single line but may in fact be several address, data, and control lines. In addition, a shown communication path may be a bus. For example, the communication paths 72 may be inter-IC or I²C busses.

The image captured by a camera is “perspective view,” that is, the image is a two-dimensional representation of a three-dimensional scene as viewed from a “center of perspective” or “COP.” The center of perspective is the entrance pupil of the camera lens. The entrance pupil is the image of the diaphragm as seen from the front of the lens. The location of the center of perspective depends on the focal length and focus position of the lens. Depending on how a lens is designed and adjusted, the center of perspective may be located at different points along the optical axis 48 of the lens. In some cases, the center of perspective may be behind or in front of the lens. During the capture of two or more images to be combined to form a panorama, the adjustment of the lens and accordingly the center of perspective are typically fixed. If the position or location of the camera 20 in three-dimensional space is changed during the capture process, i.e., the camera body 22 is translated along one or more of the axes, then the center of perspective is also changed.

Referring to FIG. 4, a panoramic image may be created by capturing images of two or more adjacent views with the camera 20 and then “stitching” the images 76 together. When the camera 20 is operated in panoramic mode, the images 76 are captured so that the fields of view of adjacent images overlap one another. (Areas of overlap are designated by reference number 78.) As one example, the images 76 may have an overlap of 10°. After capture, the images 76 are positioned so that the overlapping regions of adjacent images are aligned. Once aligned, the images 76 are joined and the edges of adjacent images may be blended to form a seamless panoramic image. Stitched or “segmented” panoramas may be created using special-purpose image stitching software. The stitching operation may be performed in a computer system separate from the camera 20. In one embodiment, the stitching operation may be performed in the camera 20. The stitching technique may be used to create, for example, a 100° panorama in a traditional photographic application, or a 360° cylindrical panorama in a computer graphic or VR application.

FIG. 5 shows a first field of view that may be captured by the camera 20 when the camera is being operated in panoramic mode. The initial orientation of the camera 20 in the X-Z plane is in direction D₀. The angle of view is θ. The center of perspective is denoted COP₀. Objects 80 and 82 are in the field of view. Image 84 is a representation of a first image that is captured when the camera 20 is oriented to capture the first field of view.

FIG. 6 shows a first example of a second field of view that may be captured by the camera 20 when the camera is being operated in panoramic mode. The orientation of the camera 20 in the X-Z plane is second direction D₁. The angle of view is θ. The center of perspective is denoted COP₁. Image 86 is a representation of a second image that is captured when the camera 20 is oriented to capture the second field of view. It may be seen that the objects 80 and 82 are similarly located relative to one another in both first and second images 84 and 86. In FIGS. 5 and 6, the first and second images correspond with the same camera position, i.e. the centers of perspective COP₀ and COP₁ are located at the same point in the X-Z plane, however, this is not always the case in practice.

When capturing two or more images that will be stitched together to form a cylindrical or spherical panorama, it is generally important that the camera position is not changed, i.e., each image is captured from the same center of perspective. When moving the camera to capture a second image after capturing a first image, a failure to maintain the center of perspective of the camera at the same point in space for each captured image can result in parallax errors.

FIG. 7 shows a second example of the second field of view that may be captured by the camera 20 when the camera is being operated in panoramic mode. Image 88 is a representation of a second image that is captured when the camera 20 is oriented to capture the second field of view. Like the example shown in FIG. 6, the orientation of the camera 20 in the X-Z plane is in second direction D₁. The center of perspective COP₂, however, is not located at the same point in the X-Z plane as COP₀. As a result of the change in camera position, objects 80 and 82 appear at different locations relative to one another in first and second images 84 and 88.

FIG. 8 shows a third example of the second field of view that may be captured by the camera 20 when the camera is being operated in panoramic mode. Image 90 is a representation of a second image that is captured when the camera 20 is oriented to capture the second field of view. Like the example shown in FIGS. 6 and 7, the orientation of the camera 20 in the X-Z plane is in second direction D₁. The center of perspective COP₃, however, is not located at the same point in the X-Z plane as COP₀. As a result of the change in camera position, objects 80 and 82 appear at different locations relative to one another in first and second images 84 and 90.

Parallax error may be caused because a user does not understand the need to maintain the camera's center of perspective at the same point for each image captured. For instance, a user may simply rotate the camera body about him or her self. As another example, a user may rotate the camera body about an attachment point 18 for a tripod. However, as shown in FIG. 1, the tripod attachment point often does not coincide with the center of perspective. Moreover, the user is typically unaware of the location of a particular camera's center of perspective. The center of perspective is typically not marked on the outside of the camera body or lens. Further, in cameras with having lenses with adjustable focal length and focus position of the lens, the center of perspective varies according to lens adjustment.

Parallax errors can cause a number of problems. For example, the special-purpose image stitching software may include a capability to automatically align adjacent images. Parallax errors can cause this automatic image alignment function to fail. In addition, the special-purpose image stitching software joins adjacent images and blends the edges of the images together. If parallax errors are present, when images are joined and edges blended, ghosting and blurring artifacts can be introduced into the final panorama image. Accordingly, there is a need for a method and apparatus for capturing two or more images that may be stitched together to form a panoramic image which minimizes or eliminates parallax error.

The mode dial 44 may be used to place the camera 20 in a panoramic capture mode. The menu button 32, arrow buttons 34, 36, 38, 40, select button 42 may be used to select or input various parameters that the camera 20 will use when capturing images in panoramic capture mode. One or more parameters may be input before capturing a first image. For example, the user may specify whether the camera 20 will be rotated right or left (or up or down) during image capture. The user may specify the angle of view of the panoramic image (as opposed to the field of view of a single image) and the amount of overlap between the adjacent images that will be captured to form the panoramic image. The user may specify parameters such as focal length, focus, aperture, and shutter speed when framing the first image to be captured. Once specified focal length, focus, aperture, and shutter speed, these parameters remain fixed during capture of the two or more images. The user may also specify whether images should be automatically captured when the camera is in the proper location and position. Moreover, the user may specify whether there are any objects close to the camera in the panoramic image to be captured.

One or more of the parameters that are used during the capture of two or more images may be automatically determined. In addition, one or more of the parameters may be determined subsequent to the capture of a first image. In one embodiment, the direction in which the camera is panned (right or left or up or down) is determined by the MSU 58 from rotation detected after capture of a first image. In one embodiment, the angle of view and the amount of overlap between images is automatically determined. In one embodiment, parameters such as focal length, focus, and shutter speed are automatically determined.

In panoramic capture mode, the user may frame an initial image of the scene. When the user is satisfied with how the initial scene is framed, he or she presses and holds down the shutter button 30. In one embodiment, the pressing of the shutter button 30 causes a first image to be captured. A second image and each subsequent next image are automatically captured when the camera is in the proper orientation and position. The user continues to press the shutter button 30 until the last image is captured. Releasing the shutter button 30 signals the end of panorama.

When the shutter button 30 is first pressed, an initial image is captured and stored in a memory. A copy of the initial image intended for subsequent use in an image stitching operation may be stored in memory 60. The copy stored in the memory 60 may be stored at its full resolution. Alternatively, the copy stored in memory 60 may be compressed, e.g., converted to JPEG file format, prior to storing. In one alternative, the first image is captured according to traditional means of exposing photographic film. In addition, when the shutter button 30 is first pressed, the MSU processor 68 may cause the acceleration sensor 62 and an angular rate sensor 64 to be initialized. Alternatively, initializing the sensors 62, 64 stores a location and an orientation (initial position and initial orientation) of the camera 20 at the time that the initial image was captured.

After capture of an image, the MSU processor 68 determines proper orientation and position of the camera 20 for capture of a next (second) image with respect to the location of a preceding (initial) image. This determination may be based on parameters such as direction of rotation, amount of overlap between the adjacent images, and the angular measure of the field of view of the camera. The MSU processor 68 may receive information regarding lens position from one or more sensors in the lens system 24. From received lens position information, the MSU processor 68 may calculate the field of view and the center of perspective of the camera 20. Using the initial position and initial orientation information that the MSU processor 68 receives from the acceleration sensor 62 and an angular rate sensor 64, the MSU processor may determine a target orientation and position for the camera 20. The target orientation is the ideal orientation for capture of a next image. The target orientation depends on the field of view of the camera, the specified amount of overlap between the adjacent images, and direction of rotation. The target position specifies the ideal position of the camera 20 for capture of a next image. The target position is a position in which the center of perspective is the same as the initial center of perspective. The MSU processor 68 may issue a command to the display controller 52 to render a visual indication of the target orientation and target position on a display device, e.g., the image display 28.

While the user moves the camera 20 to generally position it to capture the next image after capture of the initial image, he or she continues to press and hold the shutter button 30. As the camera 20 is moved, the MSU processor 68 receives data for determining displacement from the acceleration sensor 62 and rotation data from the angular rate sensor 64. The MSU processor 68 determines a current orientation and position of the camera 20 using the received data. This process of receiving data and determining a current orientation and position may be repeated at suitable time intervals, e.g. 50 Hz. In addition, the MSU processor 68 may repeatedly issue a command to the display controller 52 to render a visual indication of the current orientation and position on the image display 28 at suitable time intervals such that the visual indication is updated in real time, e.g., 24-100 Hz.

FIG. 9 illustrates a first example of current and target visual indications of position and orientation rendered on the image display 28. A visual indication 200 shows a representation of a side view the camera, a Y axis, a Z axis, and a dot 202. The dot 202 shows a current vertical position relative to a target vertical position. The target vertical position is indicated by the intersection of the Y and Z axes. The current vertical position dot 202 may be updated in real time. In addition, FIG. 9 shows a visual indication 204. The visual indication 204 shows a representation of a side view the camera, a Z axis, a curve in the Y-Z plane, and a dot 202. The visual indication 204 shows a current pitch orientation dot 206 relative to a target pitch orientation. The target pitch orientation is indicated by the Z axis. The current pitch orientation dot 206 may be updated in real time.

FIG. 10 illustrates a second example of current and target visual indications of position and orientation rendered on the image display 28. A visual indication 208 shows a representation of a top view of the camera, an X axis, a Z axis, and a dot 210. The dot 210 shows a current lateral position relative to a target lateral position. The target lateral position is indicated by the intersection of the X and Z axes. The current lateral position 208 may be updated in real time. In addition, FIG. 10 shows a visual indication 212. The visual indication 212 shows a representation of a top view of the camera, a Z axis, a curve in the X-Z plane, and a dot 214. The visual indication 204 shows a current yaw orientation dot 214 relative to a target yaw orientation. The target yaw orientation is indicated by the Z axis. The current yaw orientation dot 214 may be updated in real time.

FIG. 11 illustrates a third example of current and target visual indications of position and orientation rendered on the image display 28. A visual indication 216 shows a representation of a top view the camera, an X axis, a Z axis, and a dot 218. The dot 218 shows a current fore/aft position relative to a target fore/aft position. The target fore/aft position is indicated by the intersection of the X and Z axes. The current fore/aft position dot 218 may be updated in real time. In addition, FIG. 11 shows a visual indication 220. The visual indication 220 shows a representation of a user side view the camera, a Y axis, a curve in the Y-X plane, and a dot 222. The visual indication 220 shows a current roll orientation dot 222 relative to a target roll orientation. The target roll orientation is indicated by the Y axis. The current roll orientation dot 222 may be updated in real time.

FIG. 12 illustrates a fourth example of current and target visual indications of position and orientation rendered on the image display 28. A visual indication 223 shows of depictions of a first camera 224, a second camera 226, and X, Y, and Z axes. The camera 224 represents a current three-dimensional position and orientation. The camera 226 represents a target three-dimensional position and orientation. The camera 226 is aligned with the intersection of the X, Y, and Z axes. The current three-dimensional position 224 may be updated in real time. The embodiment shown in FIG. 12 is one possible way to combine the visual indications shown in FIGS. 9, 10, and 11 into a single visual indication. It is not critical that a visual indicator corresponds with a camera or that coordinate axes be included in the visual indicator.

Both current and target visual indications may be displayed on the image display 28 after a first image has been captured. As the user moves the camera into position to capture the next image, the user may compare the respective locations of the visual indication(s) of the current position or orientation with the visual indication(s) for the target position or orientation. When the current and target visual indications are aligned, the MSU processor 68 may cause a next image to be automatically captured and stored in the memory. When the dots 202 and 206 shown in FIG. 9 are aligned with the appropriate target axis, and the camera is panned laterally to the left or right side, the initial and next images will have the substantially the same vertical extent, minimizing the need for cropping tops or bottoms of images in the image stitching process. When the dots 210 and 214 shown in FIG. 10 are aligned with the appropriate target axis, and the camera is panned in an upward or downward arc, the initial and next images will have the substantially the same horizontal extent, minimizing the need for cropping sides of images in the image stitching process. When the dot 222 shown in FIG. 11 is aligned with the Y target axis, and the camera is panned either upward or downward or laterally, the initial and next images will not exhibit roll with respect to each other, minimizing the need for cropping in the image stitching process. When the dot 218 shown in FIG. 11 is aligned with the intersection of the X and Z axes, and the camera is panned either upward or downward or laterally, the initial and next images will not exhibit parallax error with respect to each other. When the current and target cameras 224, 226 shown in FIG. 12 are aligned with each other, and the camera is panned either upward or downward or laterally, the initial and next images will have all of the desirable properties just describe as being provided by the embodiments shown in FIGS. 9, 10, and 11.

As mentioned above, the user may specify whether there are any objects close to the camera in the panoramic image to be captured. If there are not any close or near objects in the desired panorama, a first condition that requires current and target positions to be aligned or equal, and a second condition that that requires current and target positions to be aligned or equal may be relaxed or eliminated. For example, the first condition may require that the current and target positions be aligned, equal, or coincide within a particular first tolerance. In addition, the second condition may require that the current and target orientations be aligned, equal, or coincide within a particular second tolerance. A judgment may be made to increase the first and second tolerances if the user specifies that there are no objects close to the camera in the panoramic image to be captured. The first and second conditions may be determined using calculated locations or orientations, or using visual indications of position or orientation on the display device. A next image may be automatically captured when the first condition, the second condition, or both conditions are satisfied. Alternatively, the capture of a next image may be inhibited until the first or the second condition is satisfied, and until both conditions are satisfied. In addition, if there are not any close or near objects in the desired panorama, visual indications of current and target positions need not, in one embodiment, include an indicator for avoiding parallax effects.

The pressing of the shutter button 30 may cause a first image to be captured. After the first image is captured, the user may continue to press the shutter button 30. Keeping the shutter button 30 depressed causes visual indication(s) of current position or orientation and visual indication(s) of target position or orientation to be displayed. A second image is automatically captured when the camera is in the proper orientation and position. If the shutter button 30 stays pressed after the capture of the second image, a new target orientation may be calculated, and visual indication(s) of current position or orientation and visual indication(s) of target position or orientation may be displayed. So long as the user continues to press the shutter button 30, each subsequent next image is automatically captured (when the current camera position/orientation coincides with the target camera position/orientation) and after capture, a new target orientation may be calculated. The process may continue until the last image is captured. Releasing the shutter button 30 signals the camera that the last image has been captured.

The shutter button may have two positions. Pressing the shutter button a first distance to a first position causes an auto-focus or an auto-exposure setting to be determined and locked. Pressing the shutter button an additional distance to a second position causes the panoramic image capture process (automatic capture of next images) to begin.

In one alternative embodiment, second and subsequent images are not automatically captured when the camera is in the proper orientation and position. Instead, the user may determine when the camera is in the proper orientation and position, and may manually cause, e.g., press a shutter button, a next or subsequent image to be captured and stored. In one embodiment, the camera may be inhibited from capturing a next image when the target and current positions are determined to be substantially unequal, determined to not substantially coincide, or determined to be substantially unaligned. The camera may allow capture of a next image either automatically or manually when the target and current positions are determined or judged to be substantially equal, to substantially coincide, or to be substantially aligned. Further, in one embodiment the camera may be inhibited from capturing a next image when the target and current orientations are determined or judged to be substantially unequal, to not substantially coincide, or to be substantially unaligned. The camera may allow capture of a next image either automatically or manually when the target and current orientations are determined or judged to be substantially equal, coincident, or aligned.

Once the next image is captured, the MSU processor 68 determines a new target orientation and position for the camera 20. The new target orientation and position are for capture of a next image. For example, if the captured image is a second image, the next image is the third image. Thus, the new target orientation and position is determined with respect to the orientation of the camera when the second image was captured. The new target orientation and position are determined based on parameters described above, the orientation of the camera when the preceding image was captured, and the initial center of perspective of the camera. As before, the MSU processor 68 receives data for determining displacement from the acceleration sensor 62 and rotation data from the angular rate sensor 64 while the camera 20 is moved into position to capture the third image. As described above, the MSU processor 68 may issue commands to the display controller 52 to render a visual indication of the current orientation and position in real time on the image display 28. As many additional “next” images as may be needed may be captured in this manner.

In determining a center of perspective, the MSU processor 68 may combine a particular displacement obtained from the acceleration sensor 62 with a particular rotation of the angular rate sensor 64. In other words, both types of sensor may be used together to determine position. Referring to FIG. 13, an example of the camera 20 and lens system 24 are shown in an orientation for capture of an initial image. FIG. 13 depicts the camera 20 and lens system 22 as viewed from the bottom side. FIG. 13 depicts example locations in the X-Z plane for a target center of perspective COP₀ and a sensor 240, which may be the acceleration sensor 62, the angular rate sensor 64, or both sensors. In FIG. 13, the optical axis of the lens system 22 is oriented in an initial direction D₀, which is aligned with the Z coordinate axis. The sensor 240 and the target center of perspective COP₀ are separated by a distance C. The X, Z coordinates of the sensor 240 are X₀ and Z₀. In addition, the sensor 240 may be offset from the target center of perspective COP₀ by an angle α. The angle α may be determined from the physical specifications for a particular camera and lens systems and stored in a memory. If the focus or focal length of the lens system is adjustable, the camera specifications may be used to determine a table of values for the angle α. corresponding with different lens configurations. The distances X₀, Zₒ, and C may be determined in a manner similar to the angle α. Alternatively, the distance C may be calculated from X₀ and Z₀.

Referring now to FIG. 14, the camera 20 and lens system 22 of FIG. 13 has been rotated generally in a direction D₁ for capture of a next image. However, the camera is not yet in an image taking position. The sensor 240 and a current center of perspective COP₁ are separated by the distance C. If the distance C is thought of as a vector, the origin of the vector is given by the displacement of the sensor 240 from its initial position shown in FIG. 13, e.g., X₂ and Z₂. The displacement distances X₂ and Z₂ may be determined by the MSU processor 68 from data received from the acceleration sensor 62. The sensor 240 is offset from the current center of perspective COP₁ by the angle α. In addition, the sensor 240 has been rotated from its initial position by an angle β. The angle β may be determined by the MSU processor 68 using data received from the angular rate sensor 64. Thus, a vector originating at (X₀+X₂, Z₀−Z₂), having a length C, and making an angle α+β with the Z axis may be used in one embodiment to define a current center of perspective COP₁.

Placement of the acceleration sensor 62 and angular rate sensor 64 is not limited to the location shown in FIGS. 13 and 14. In one embodiment, the acceleration sensor 62 and angular rate sensor 64 may be placed at any desired location within the body 22. In addition, in one embodiment one or both of the acceleration sensor 62 and angular rate sensor 64 may be placed in the lens system 24. In one embodiment, one or both sensors may be placed in the lens system 24 adjacent, proximate, or very near a center of perspective. For example, a sensor may be mounted in a lens barrel to the side of the optical axis. One or both sensors may be mounted so that the position of the sensor moves fore or aft along with any change in position of the center of perspective in an adjustable lens system, the amount of movement corresponding with the change in position of the center of perspective.

Referring to FIG. 15, a process 100 for capturing two or more images that may be stitched together to form a panoramic image while minimizing or eliminating parallax error using a camera is next described. Parametric information defining the type of panoramic image may be input in an operation 102. Alternatively, some or all of the parametric information may be automatically determined by the camera. In addition, it is not critical that parametric information be input or automatically determined prior to all of the operations shown in FIG. 15. One or more of the parameters may be determined subsequent to the capture of an initial image. Examples of parametric information are given above.

In operation 104, the camera 20 may be placed in a panoramic image capture mode. To place the camera 20 into panoramic image capture mode, the user may turn the mode dial 44 to an appropriate position. In operation 106, an initial image may be captured and stored in a memory. The initial image may be captured using the camera 20 and stored in a memory in response to the user pressing the shutter button 30.

In operation 108, the acceleration sensor 62 may be initialized in response to the pressing of the shutter button 30. Alternatively, the initial position of the camera 20 at the time that the initial image was captured may be determined in operation 106. The initial position is the position of the center of perspective associated with the initial image.

In operation 110, the angular rate sensor 64 may be initialized in response to the pressing of the shutter button 30. Alternatively, the initial orientation of the camera 20 at the time that the initial image was captured may be determined in operation 108. The initial orientation is the orientation of the camera 20 at the time the initial image is captured. Moreover, operation 100 may be performed after either operation 108 or operation 126. If the operation 110 is performed after operation 108 and at substantially the same time that the initial image is captured, the initial orientation determined in operation 110 is with reference to the initial image. On the other hand, if the operation 110 is performed after operation 126, the “initial” orientation determined in operation 110 is an orientation of the camera 20 at substantially the same time as the capture of a “next” image. A next image is any image other than the initial image and there may be N−1 next images when N images are needed for combining into a panorama. Thus, a next “Nth” orientation of the camera 20 may be determined in operation 110.

In an operation 112, the MSU processor 68 determines a target orientation for the camera 20 for the capture of a next image. The target orientation is the ideal orientation for capture of a next image. If the preceding image is the initial image, the next image is a second image. If the preceding image is the second image, the next image is a third image, and so on. The target orientation is determined with respect to the location of the preceding image. The MSU processor 68 determines target orientation using parameters such as field of view of the camera, the specified amount of overlap between the adjacent images, and direction of rotation. The MSU processor 68 receives data from the acceleration sensor 62 and an angular rate sensor 64, and may retrieve orientation information pertaining to the preceding image from a memory.

In operation 114, the MSU processor 68 may issue a command to the display controller 52 to render a visual indication of the target orientation on the image display 28. In addition, the MSU processor 68 may issue a command to the display controller 52 to render a visual indication of a target position on the image display 28. The MSU processor 68 may retrieve from a memory the initial position of the camera 20 at the time that the initial image was captured for use as the target position.

In operation 116, the MSU processor 68 may receive data for determining displacement from the acceleration sensor 62 and determine a current position or center of perspective of the camera 20 using the received data. The displacement may be determined with respect to the target position. Operation 116 may be repeated at suitable time intervals, e.g. 50 Hz.

In operation 118, the MSU processor 68 may receive rotation data from the angular rate sensor 64 and determine a current orientation of the camera 20 using the received data. The current orientation may be determined with respect to the target orientation. Operation 118 may be repeated at suitable time intervals.

In an operation 120, the MSU processor 68 may issue commands to cause one or more visual indications of the current orientation or current position or both to be rendered on the image display 28. The operation 120 may be repeated at suitable time intervals such that the visual indication is updated in real time with current data received from the sensors 62 and 64, e.g. 50 Hz.

In an operation 122, the MSU processor 68 compares the current orientation of the camera 20 with a target orientation. The MSU processor 68 may make two orientation comparisons, one for each of two planes. For example, the MSU processor 68 may compare the current orientation of the camera 20 in an X-Y plane and an X-Z plane with a target orientation. For example, when the camera is moved horizontally to capture the two or more images, the camera must be rotated a particular number of degrees in the X-Z plane to capture a next image. At the same time, the camera should not be rotated, i.e., tilted up or down, in the X-Y plane. Accordingly, the MSU processor 68 may compare the current direction of the camera with the target direction in the X-Z plane in order to determine if the camera has been rotated horizontally by the correct number of degrees. In addition, the MSU processor 68 may compare the current direction of the camera with the target direction in the X-Y plane in order to determine that the camera has not been tilted up or down as it was rotated. If the MSU processor 68 determines that the current and target orientations differ, the process 100 returns to operation 116.

In an operation 123, the MSU processor 68 may compare the current position of the camera 20 with a target position. The MSU processor 68 may use data from both the acceleration and angular rate sensors to determine a current position. If the MSU processor 68 determines that the current and target positions differ, the process 100 returns to operation 116.

If the MSU processor 68 determines that both the current and target orientations are equivalent and the current and target positions are equivalent, the process 100 proceeds to operation 124, where a next image is captured and saved in a memory. The next image may be automatically captured by the camera.

In operation 126, the MSU processor 68, using the specified angle of view of the panoramic image and the specified amount of overlap between images determines if the capture of additional images is required. If one or more images need to be captured, the process 100 proceeds to operation 110. Otherwise, the process 100 proceeds to operation 128, where the panoramic capture mode is terminated.

At the conclusion of the process 100, two or more images that may be combined to form a panoramic image are stored in a memory, e.g., the memory 60. If the process 100 was performed correctly, each image should have at least on region of overlap with at least one other of the images. The overlap region should be of the specified size. In addition, each image should have been captured from the same center of perspective. The two or more images may be combined using software that the host processor 46 executes. Alternatively, the two or more images may be transferred from the memory 60 to a personal computer or other device, and combined using image stitching software that runs on the other device. Where the images were captured using photographic film, the film may be processed and the resulting images may be converted to digital images prior to being combined by stitching software.

It should be understood that the embodiments described above may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed may be referred to in terms, such as producing, identifying, determining, or comparing.

Any of the operations described in this specification that form part of the embodiments are useful machine operations. As described above, some embodiments relate to a device or an apparatus specially constructed for performing these operations. It should be appreciated, however, that the embodiments may be employed in a general purpose computer selectively activated or configured by a computer program stored in the computer. In particular, various general purpose computer systems may be used with computer programs written in accordance with the teachings herein. Accordingly, it should be understood that the embodiments may also be embodied as computer readable code on a computer readable medium.

A computer readable medium is any data storage device that can store data which can be thereafter read by a computer system. Examples of the computer readable medium include, among other things, floppy disks, memory cards, hard drives, RAMs, ROMs, EPROMs, compact disks, and magnetic tapes.

Although the present invention has been fully described by way of the embodiments described in this specification with reference to the accompanying drawings, various changes and modifications will be apparent to those having skill in this field. Therefore, unless these changes and modifications depart from the scope of the present invention, they should be construed as being included in this specification.

1. A camera, comprising:
a display device;
an angular velocity sensor to sense yaw rotation of the camera when the camera is moved, the angular velocity sensor being at a first location with respect to and away from a center of perspective;
an acceleration sensor to sense lateral and fore/aft acceleration of the camera when the camera is moved, the acceleration sensor being at a second location with respect to and away from the center of perspective;
a memory to store the first and second locations; and
a processor to determine:
an initial position when an initial image is captured, the initial position corresponding with the center of perspective,
a target position for capturing a next image, the target position corresponding with the initial position, and
a current position from rotation sensed by the angular velocity sensor, acceleration sensed by the acceleration sensor, and the stored first and second locations,
wherein the processor causes a visual indication of the target position and a visual indication of the current position to be rendered on the display device.

2. The camera of claim 1, wherein the processor further determines when the target and current positions are in substantial alignment and the camera automatically captures the next image when the target and current positions are in substantial alignment.

3. The camera of claim 1, wherein the processor further determines when the target and current positions are in substantial alignment and allows capture of the next image when the target and current position when the target and current positions are in substantial alignment.

4. The camera of claim 1, wherein the processor further determines initial, target, and current orientations, and causes a visual indication of the target orientation and a visual indication of the current orientation to be rendered on the display device.

5. The camera of claim 4, wherein the processor further determines when the target and current positions are in substantial alignment and when the target and current orientations are in substantial alignment, and the camera automatically captures the next image when both the target and current positions are in substantial alignment and the target and current orientations are in substantial alignment.

6. The camera of claim 4, wherein the processor further determines when the target and current positions are in substantial alignment and when the target and current orientations are in substantial alignment, and allows capture of the next image when both the target and current positions are in substantial alignment and the target and current orientations are in substantial alignment.

7. The camera of claim 4, wherein the determining of the target orientation of the camera includes determining that a next image to be captured will overlap a preceding image by a particular amount.

8. The camera of claim 4, wherein the angular velocity sensor further senses roll rotation of the camera when the camera is moved, and the determining of the target orientation of the camera includes determining a target roll orientation.

9. The camera of claim 4, wherein the angular velocity sensor senses pitch rotation of the camera when the camera is moved, and the determining of the target orientation of the camera includes determining a target pitch orientation.

10. The camera of claim 1, wherein the center of perspective is variable and the memory stores:
two or more first locations of the angular velocity sensor with respect to the center of perspective, each first location corresponding with a possible center of perspective, and
two or more second locations of the acceleration sensor with respect to the center of perspective, each second location corresponding with a possible center of perspective.

11. The camera of claim 1, wherein the acceleration sensor further senses vertical acceleration of the camera when the camera is moved, and the determining of the target position for capturing a next image includes determining a target position for capturing a next image in a three-dimensional space.

12. A method for capturing two or more images, comprising:
capturing an initial image of a scene using a camera;
determining a target position for the camera, wherein the target position of the camera coincides with a center of perspective determined at substantially the same time as the capturing of the initial image;
sensing at least one current position of the camera subsequent to the capturing of the initial image using an acceleration sensor, wherein the current position coincides with a current center of perspective; and
displaying on a display device an indication of the target and current positions of the camera.

13. The method of claim 12, further comprising judging when the target and current positions substantially coincide, and capturing a next image when the target and current positions substantially coincide.

14. The method of claim 12, further comprising judging when the target and current positions substantially coincide, and allowing the capturing of a next image when the target and current positions substantially coincide.

15. The method of claim 12, wherein the method is embodied as computer readable code on a computer readable medium embodying a program of instructions for execution by a computer.

16. The method of claim 12, further comprising sensing an initial orientation of the camera at substantially the same time as the capturing of the initial image, sensing at least one current orientation of the camera subsequent to the capturing of the initial image using an angular velocity sensor, and determining a target orientation of the camera.

17. The method of claim 16, further comprising judging when the target and current positions substantially coincide, when the target and current orientations substantially coincide, and capturing a next image when both the target and current positions substantially coincide and the target and current ordinations substantially coincide.

18. A camera, comprising:
a first sensor to sense fore/aft displacement along a Z axis of the camera when the camera is moved, the Z axis corresponding with an optical axis of the camera when an initial image is captured, wherein an X axis corresponds with a lateral position of the camera when the initial image is captured, a Y axis corresponds with a vertical movement of the camera when the initial image is captured, and the X, Y, and Z axes are orthogonal to one another; and
a processor to determine:
an initial position when the initial image is captured, the initial position corresponding with a center of perspective,
a target position for capturing a next image, the target position corresponding with the initial position,
a current position from sensed fore/aft displacement, and
determines when the target and current positions are substantially equal, and allows capture of a next image when the target and current positions are determined to be substantially equal.

19. The camera of claim 18, wherein the camera automatically captures a next image when the target and current positions are determined to be substantially equal.

20. The camera of claim 18, further comprising a display device, wherein the processor causes a visual indication of the target position and a visual indication of the current position to be rendered on the display device.

21. The camera of claim 18, further comprising a lens system, wherein the first sensor is located within the lens system and proximate to the center of perspective.

22. The camera of claim 18, wherein the first sensor further senses lateral displacement of the camera along the X axis when the camera is moved, and the first sensor is located at a location away from the center of perspective.

23. The camera of claim 18, further comprising a second sensor to sense yaw rotation of the camera about the Y axis when the camera is rotated, wherein the processor further determines initial, target, and current orientations, and causes a visual indication of the target orientation and a visual indication of the current orientation to be rendered on the display device.

24. The camera of claim 23, wherein the processor further determines when the target and current positions are substantially equal and when target and current positions are substantially equal, and the camera automatically captures a next image when both the target and current positions are determined to be substantially equal, and the target and current orientations are determined to be substantially equal.

25. The camera of claim 23, wherein the processor further determines when the target and current positions are substantially equal and when target and current positions are substantially equal, and the camera allows capture of a next image when both the target and current positions are determined to be substantially equal, and the target and current orientations are determined to be substantially equal.

26. The camera of claim 18, further comprising a lens system and a second sensor to sense yaw rotation of the camera about the Y axis when the camera is rotated, wherein the second sensor is located within the lens system and proximate to the center of perspective.
